(19) United States
(12) Patent Application Publication
(10) Pub. No.: US 2016/0379300 A1
(43) Pub. Date: Dec. 29, 2016

(54) PREDICTION DEVICE, PREDICTION METHOD, AND NON-TRANSITORY COMPUTER READABLE STORAGE MEDIUM

(71) Applicant: YAHOO JAPAN CORPORATION, Tokyo (JP)

(72) Inventors: Naoki HIRAI, Tokyo (JP); Koji TSUKAMOTO, Tokyo (JP); Junichiro KITAGAWA, Tokyo (JP); Katsushi YAMASHITA, Tokyo (JP); Satoshi YAMAUCHI, Tokyo (JP); Akira TAJIMA, Tokyo (JP)

(73) Assignee: YAHOO JAPAN CORPORATION, Tokyo (JP)

(21) Appl. No.: 15/188,130

(22) Filed: Jun. 21, 2016

(30) Foreign Application Priority Data
Jun. 24, 2015 (JP) 2015-126976

(51) Int. Cl. G06Q 30/08; G06N 5/04

(52) U.S. Cl. CPC G06Q 30/08; G06N 5/04

(57) ABSTRACT

A prediction device according to the present application includes an acquisition unit and a prediction unit. The acquisition unit acquires information on a current price at which a target product is bid at an auction. The prediction unit predicts a price difference between the current price and a future price at which the target product is assumed to be bid after bidding at the current price based on the information on the current price acquired by the acquisition unit and a bid history at the auction. For example, the prediction unit predicts a price difference between the current price and the future price at which the target product is assumed to be bid immediately after bidding at the current price.

### CROSS-REFERENCE TO RELATED APPLICATION(S)

The present application claims priority to and incorporates by reference the entire contents of Japanese Patent Application No. 2015-126976 filed in Japan on Jun. 24, 2015.

### BACKGROUND OF THE INVENTION

1. Field of the Invention

The present invention relates to a prediction device, a prediction method, and a non-transitory computer readable storage medium.

2. Description of the Related Art

Conventionally, techniques for facilitating auction management have been provided. For example, a technique for determining which product put at an auction is to be bid based on the current price of the product has been provided.

This conventional technique can improve convenience for a user participating in the auction, but does not necessarily facilitate management by a provider of the auction. For example, when it is difficult to appropriately predict a profit obtained from each product, it is also difficult to facilitate management at the auction.

### SUMMARY OF THE INVENTION

It is an object of the present invention to at least partially solve the problems in the conventional technology.

According to one aspect of an embodiment, a prediction device includes an acquisition unit that acquire information on a current price at which a target product is bid at an auction, and a prediction unit that predict a price difference between the current price and a future price at which the target product is assumed to be bid after bidding at the current price based on the information on the current price acquired by the acquisition unit and a bid history at the auction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of prediction processing according to an embodiment;

FIG. 2 is a diagram illustrating an exemplary configuration of a prediction device according to the embodiment:

FIG. 3 is a diagram illustrating an exemplary bid history information storage unit according to the embodiment;

FIG. 4 is a diagram illustrating an exemplary auction information storage unit according to the embodiment;

FIG. 5 is a diagram illustrating an exemplary prediction information storage unit according to the embodiment;

FIG. 6 is a diagram illustrating an exemplary configuration of a terminal device according to the embodiment;

FIG. 7 is a flowchart of an example of the prediction processing according to the embodiment;

FIG. 8 is a diagram illustrating an example of prediction processing according to a first modification;

FIG. 9 is a diagram illustrating an exemplary configuration of a prediction device according to the first modification;

FIG. 10 is a diagram illustrating an exemplary configuration of a prediction device according to a second modification;

FIG. 11 is a diagram illustrating an example of a prediction information storage unit according to the second modification; and

FIG. 12 is a hardware configuration diagram illustrating an exemplary computer that achieves functionality of a prediction device.

### DETAILED DESCRIPTION OF THE PREFERRED EMBODIMENTS

Hereinafter, modes (hereinafter, referred to as “embodiments”) for achieving a prediction device, a prediction method, and a prediction program according to the present application will be described below in detail with reference to the accompanying drawings. The embodiments, however, do not limit the prediction device, the prediction method, and the prediction program according to the present application. In the following description of the embodiments, any identical part is denoted by an identical reference sign, and any duplicate description will be omitted.

### Embodiments

### 1. Prediction Processing

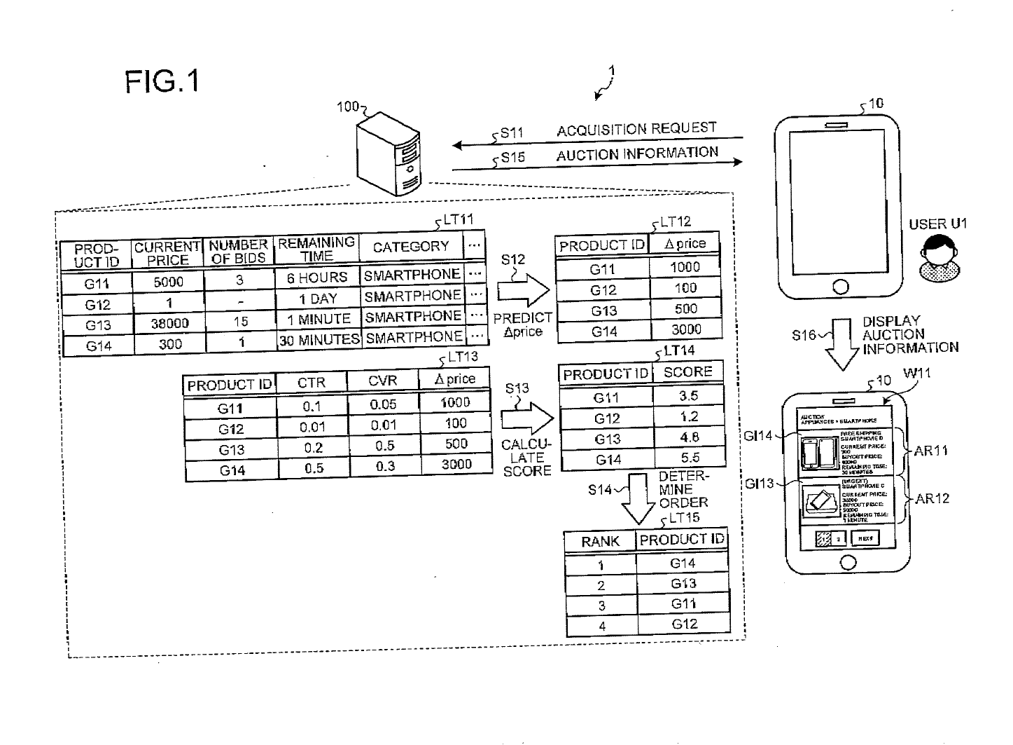

First, exemplary prediction processing according to an embodiment will be described with reference to FIG. 1. FIG. 1 is a diagram illustrating the exemplary prediction processing according to the embodiment. A prediction device 100 illustrated in FIG. 1 predicts a price difference between the current price of a target product and, a future price at which the target product is assumed to be bid immediately after bidding at the current price. Then, the prediction device 100 provides a terminal device 10 with information on an auction based on the predicted price difference. Hereinafter, the price difference predicted by the prediction device 100 is also referred to as a “Δprice”.

As illustrated in FIG. 1, the terminal device 10 and the prediction device 100 are included in a prediction system 1. The terminal device 10 and the prediction device 100 are connected with each other through a predetermined network not illustrated so as to enable wired or wireless communication therebetween. The prediction system 1 illustrated in FIG. 1 may include a plurality of the terminal devices 10 and a plurality of the prediction devices 100.

The terminal device 10 is an information processing device used by a user. The terminal device 10 requests the prediction device 100 to acquire auction information in accordance with an operation by the user. In the following, the terminal device 10 is also referred to as the user. In other words, the user and the terminal device 10 are interchangeably used in the following description. The terminal device 10 described above is, for example, a smartphone, a tablet terminal, a laptop personal computer (PC), a desktop PC, a mobile phone, or a personal digital assistant (PDA).

The prediction device 100 predicts the Δprice based on a bid history at an auction and a current price at which a target product is bid. The prediction device 100 prioritizes a target product having a higher priority based on the Δprice among a plurality of target products, and provides information on the target product as information on the auction. Alternatively, the prediction device 100 prioritizes, among the target products, a target product having a higher priority based on the Δprice related to each target product, the number of times that a page for an auction related to the target product has been selected, and the number of times that the target product has been bid, and provides information on the target product.

In the example illustrated in FIG. 1, the prediction device 100 provides the terminal device 10 with, as information on an auction, list information in which information on a target product having a higher priority based on the Δprice related to each target product, a click through rate (CTR), and a conversion rate (CVR) is displayed at a higher place. In the example illustrated in FIG. 1, the CTR is a value obtained by dividing the number of times that an operation (click) to transition to a page for an auction related to a target product is performed by the number of times that information on the target product is displayed. In the example illustrated in FIG. 1, the CVR is a value obtained by dividing the number of times that a target product is bid by the number of times that a page for an auction related to the target product is displayed. In examples described below, the priority is also referred to as a “rank” or “order”.

First, the terminal device 10 transmits a request to acquire auction information to the prediction device 100 (step S11). In the example illustrated in FIG. 1, the terminal device 10 transmits a request to acquire auction information categorized into a category “smartphone” to the prediction device 100. For example, upon selection of the category “smartphone” at an auction site displayed on a predetermined application or a predetermined browser, the terminal device 10 transmits a request to acquire the auction information categorized into the category “smartphone” to the prediction device 100. The following description is made on an assumption that a target product is a product categorized into the category “smartphone”.

Having acquired the acquisition request from the terminal device 10, the prediction device 100 predicts the Δprice related to the product categorized into the category “smartphone” (step S12). In the example illustrated in FIG. 1, information on an auction held by the prediction device 100 includes four products G11 to G14 as products categorized into the category “smartphone”. The prediction device 100 predicts the Δprices of the products G11 to G14 based on information LT11 on the products G11 to G14 including current prices, and a model generated in advance to predict the Δprice. For example, the prediction device 100 predicts the Δprice of the product G11 based on information on the product G11 including its current price, and the model generated in advance for predicting the Δprice. The model for predicting the Δprice is generated based on a bid history at an auction, which is described in detail later.

The Δprices of the products G11 to G14 predicted by the prediction device 100 at step S12 are indicated by information LT12 on the Δprices of the products G11 to G14. For example, the prediction device 100 predicts the Δprice of the product G11 to be 1000 yen. In other words, the prediction device 100 predicts the Δprice to be 1000 yen, which is a price difference between the current price of 5000 yen and a future price at which the product G11 is assumed to be bid immediately after bidding at the current price. Similarly, the prediction device 100 predicts the Δprice of the product G12 to be 100 yen, the Δprice of the product G13 to be 500 yen, and the Δprice of the product G14 to be 3000 yen.

Thereafter, the prediction device 100 calculates a score as a reference for determining the rank of each product based on the Δprice predicted at step S12 and other values related to advertisements (step S13). In the example illustrated in FIG. 1, the prediction device 100 calculates the score based on the Δprice, the CTR, and the CVR. In the example illustrated in FIG. 1, the Δprice, the CTR, and the CVR as indices of the products G11 to G14, which are used to calculate the score, are indicated in score calculation information LT13. For example, the CTR of the product G11 is 0.1, the CVR of the product C11 is 0.05, and the Δprice of the product G11 is 1000 yen.

The prediction device 100 calculates the score through a function for adjusting a weight of each index with the index as an input variable, and this score calculation will be described later. The scores of the products G11 to G14 calculated by the prediction device 100 at step S13 are indicated by information LT14 on the scores of the products G11 to G14. In the example illustrated in FIG. 1, the prediction device 100 calculates the score of the product G11 to be 3.5, the score of the product G12 to be 1.2, the score of the product G13 to be 4.8, and the score of the product G14 to be 5.5.

Thereafter, the prediction device 100 determines the orders (ranks) of the products G11 to G14 based on the scores calculated at step S13 (step S14). In the example illustrated in FIG. 1, the prediction device 100 determines that a product having a higher score is a product having a higher priority. In other words, the ranks of the products G11 to G14 determined by the prediction device 100 at step 214 are indicated by information LT15 on the ranks of the products G11 to G14. Specifically, the prediction device 100 determines the product G14 having the highest score to be the first rank, the product G13 having the next highest score fallowing the product G14 to be the second rank, the product G11 having the next highest score following the product G13 to be the third rank, and the product G12 having the lowest score to be the fourth rank.

After having determined the ranks of the products G11 to G14, the prediction device 100 provides auction information to the terminal device 10, which has transmitted the acquisition request at step S11 (step S15). For example, the prediction device 100 provides, as the auction information, list information in which information on a product having a higher rank is displayed at a higher place. In the example illustrated in FIG. 1, the prediction device 100 provides the terminal device 10 with list information displayed in the order of the products G14, G13, G11, and G12 as the auction information.

Having received the auction information from the prediction device 100, the terminal device 10 displays the received auction information (step S16). For example, the terminal device 10 displays, at a higher place, information on a product having a higher rank.

In the example illustrated in FIG. 1, the terminal device 10 displays auction information GI14 on the product G14 at the first rank in a region AR11 that displays information on a product having the highest rank, on a page W11 that displays auction information of the category “smartphone”. The terminal device 10 also displays auction information GI13 on the product G13 at the second rank in a region AR12 that displays information on a product having the second highest rank, on the page W11. In the example illustrated in FIG. 1, when a user U1 touches displayed “NEXT” and “2”, the terminal device 10 displays auction information on the product G11 at the third rank and auction information on the product G12 at the fourth rank. In this manner, the terminal device 10 displays information on the products based on the ranks determined by the prediction device 100.

As described above, the prediction device 100 predicts the Δprices of the products G11 to G14 based on information on the current price and the model. The Δprice is information that enables appropriate prediction of which product provides a large profit in the future. In other words, the prediction device 100 can accurately predict an immediate profit from the Δprice. The prediction device 100 can perform auction management including the Δprice as a factor indicating which product provides a profit. Thus, the prediction device 100 can facilitate auction management by using the Δprice enabling appropriate prediction of a future profit.

The prediction device 100 also determines the ranks of the products G11 to G14 based on the scores calculated in accordance with the Δprices of the products G11 to G14. In this manner, the prediction device 100 can appropriately rank the products based on the difference between a current price and a future price. The prediction device 100 calculates the scores based on other indices such as the CTR and the CVR in addition to the Δprices. The prediction device 100 adjusts the weight of each index by changing the function of the index as an input variable as appropriate. Thus, the prediction device 100 calculates the scores in combination of various kinds of indices, thereby appropriately determining the ranks based not only on the future profit but on any other evaluation reference.

The prediction device 100 also provides the terminal device 10 with, as auction information, list information in which information on a product having a higher rank is displayed at a higher place. Then, having received the auction information from the prediction device 100, the terminal device 10 displays the auction information in descending order of rank. In this manner, the prediction device 100 can provide the information on the products in a desired order to the user by adjusting the weight of each index as appropriate.

The prediction device 100 may employ, as the Δprice, a value other than the price difference between the current price of a product and the future price at which the product is assumed to be bid immediately after bidding at the current price. For example, the prediction device 100 may predict the Δprice by using a future price at which the product is assumed to be bid at any bidding, for example, the second or third bidding after bidding at the current price. For example, the prediction device 100 may employ, as the Δprice, a price difference between the current price of a product and a future price at which the product is assumed to be bid at the second bid after bidding at the current price. The prediction device 100 may acquire various pieces of information on an auction from an external device that provides an auction service, and perform the prediction processing. Alternatively, the prediction device 100 may provide auction service and perform the prediction processing based on various pieces of information on an auction.

### 2. Configuration of Prediction Device

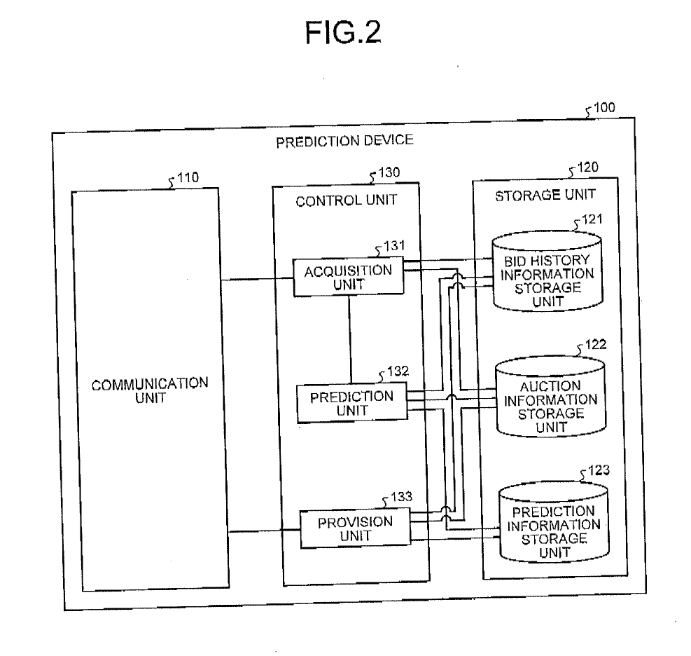

Next, the configuration of the prediction device 100 according to the embodiment will be described with reference to FIG. 2. FIG. 2 is a diagram illustrating an exemplary configuration of the prediction device 100 according to the embodiment. As illustrated in FIG. 2, the prediction device 100 includes a communication unit 110, a storage unit 120, and a control unit 130. The prediction device 100 may include an input unit (for example, a keyboard or a mouse) configured to receive various operations from, for example, an administrator of the prediction device 100, and a display unit (for example, a liquid crystal display) that displays various pieces of information.

The communication unit 110 is, for example, a network interface card (NIC). The communication unit 110 is connected with the network in a wired or wireless manner, and communicates information with the terminal device 10.

### Storage Unit 120

The storage unit 120 is, for example, a semiconductor memory element, such as a random access memory (RAM) and a flash memory, or a storage device, such as a hard disk and an optical disk. As illustrated in FIG. 2, the storage unit 120 according to the embodiment includes a bid history information storage unit 121, an auction information storage unit 122, and a prediction information storage unit 123.

### Bid History Information Storage Unit 121

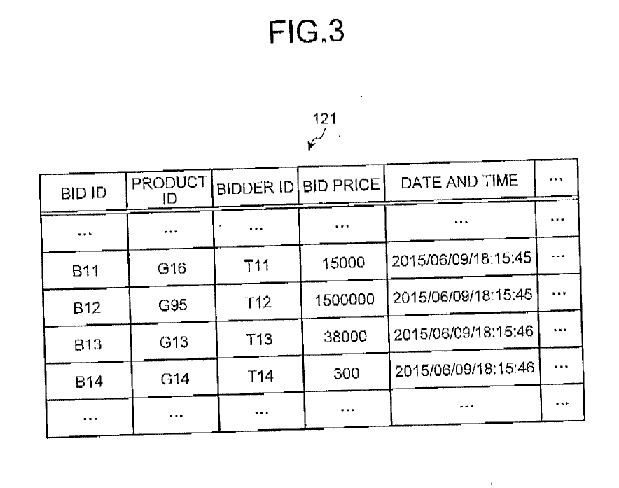

The bid history information storage unit 121 according to the embodiment stores therein information on a bid history. FIG. 3 illustrates example information on a bid history stored in the bid history information storage unit 121. As illustrated in FIG. 3, the bid history information storage unit 121 stores therein items of “bid ID”, “product ID”, “bidder ID”, “bid price”, and “date and time” as the information on a bid history.

The “bid ID” indicates identification information for identifying a bid. The “product ID” indicates identification information for identifying a product (article at auction) corresponding to the bid. The “bidder ID” indicates identification information for identifying a user who has performed the bid. The “bid price” indicates a bid price corresponding to the bid. The “date and time” indicates date and time at which the bid was performed.

In the example illustrated in FIG. 3, a bid identified by bid ID “B11” is related to a product identified by product ID “G16”, and indicates the bid was performed by a user identified by bidder ID “T11”. It is also indicated that a bid identified by bid ID “B11” has a bid price of “15000 yen”, and date and time at which the bid was performed is “18:15:45 on Jun. 9, 2015”.

The above describes exemplary information on a bid history, and the bid history information storage unit 121 may store therein various pieces of information on a bid history depending on purposes. For example, the bid history information storage unit 121 may store therein information on a seller.

### Auction Information Storage Unit 122

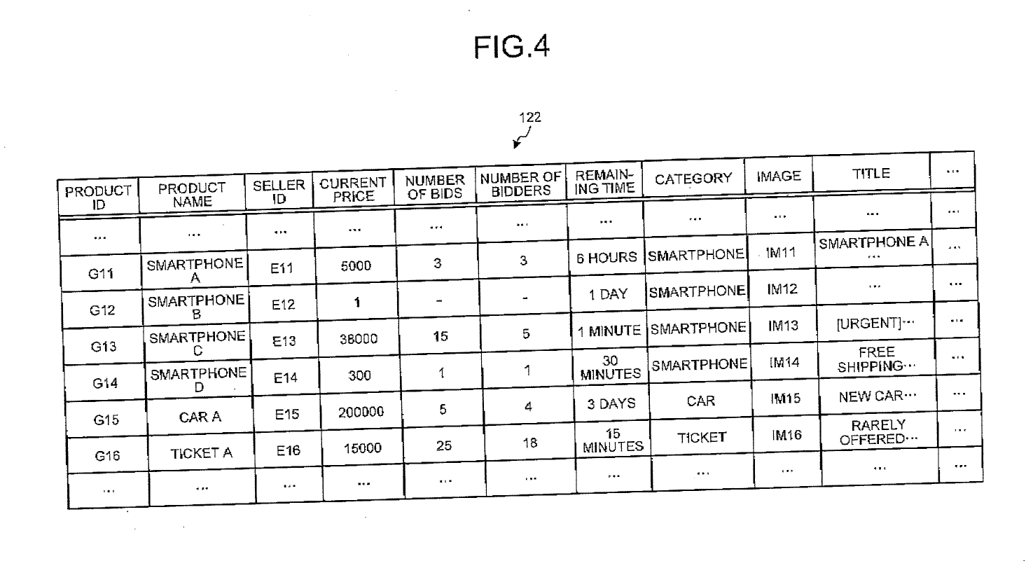

The auction information storage unit 122 according to the embodiment stores therein information on an auction. For example, the auction information storage unit 122 stores therein detailed information on a product put at an auction. FIG. 4 lists exemplary information on an auction stored in the auction information storage unit 122. As listed in FIG. 4, the auction information storage unit 122 stores therein, as the information on an auction, items of “product ID”, “product name”, “seller ID”, “current price”, “number of bids”, “number of bidders”, “remaining time”, “category”, “image”, and “title”.

The “product ID” indicates identification information for identifying a product (article at auction) corresponding to a bid. The “product name” indicates the name of a product identified by the product ID. The “seller ID” indicates identification information for identifying a user who has put a corresponding product at an auction. The “current price” indicates a bid price at which the latest bidding was made. For example, the “current price” indicates a bid price at which a right to buy is currently obtained. The “number of bids” indicates the number of bids made so far. The “number of bidders” indicates the number of users who have made bidding so far. The “remaining time” indicates the remaining time of an auction of the product identified by the product ID. The “category” indicates a category into which the product identified by the product ID is categorized. The “image” indicates an image such as a picture of the product identified by the product ID. FIG. 4 illustrates the example in which notional information such as “IM11” is stored as the “image”, but in reality, a still image or a file path indicating its storage location is stored.

The example illustrated in FIG. 4 indicates that a product identified by product ID “G11” has a product name of “smartphone A”, and its seller is a user identified by seller ID “E11”. It is also indicated that the product identified by product ID “G11” has a current price of “5000 yen”, the number of bids and the number of bidders are currently “3”, and the remaining time of the auction is “6 hours”, It is also indicated that the product identified by product ID “G11” is in a category of “smartphone”, and its image is “IM11”.

The auction information storage unit 122 is not limited to the above description, but may store therein various pieces of information depending on purposes. For example, the auction information storage unit 122 may store therein information such as an auction ID for identifying an auction.

### Prediction Information Storage Unit 123

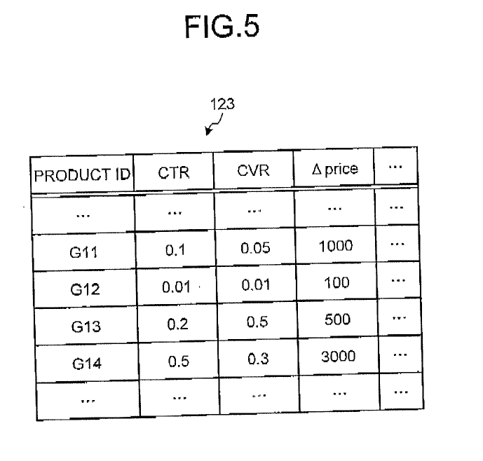

The prediction information storage unit 123 according to the embodiment stores therein various pieces of information on indices used in the score calculation. FIG. 5 illustrates an example of the prediction information storage unit 123 according to the embodiment. The prediction information storage unit 123 illustrated in FIG. 5 stores therein items of “product ID”, “CTR”, “CVR”, and “Δprice”.

The “product ID” indicates identification information for identifying a product (article at auction) corresponding to a bid. The “CTR” indicates a value obtained by dividing the number of times that an operation (click) to transition to a page for an auction related to the product identified by the product ID has been performed by the number of times that information on the product has been displayed. The “CVR” indicates a value obtained by dividing the number of times that the product identified by the product ID has been bid by the number of times that the page for the auction related to the product has been displayed. Actual measured CTR and CVR values or estimated CTR and CVR values estimated by various kinds of conventional techniques may be stored as the “CTR” and the “CVR”. The “Δprice” indicates a value of the Δprice as a price difference between the current price of the product identified by the product ID and a future price at which the product is assumed to be bid immediately after bidding at the current price.

The example illustrated in FIG. 5 indicates that a product identified by product ID “G13” has a CTR of “0.2”, a CVR of “0.5”, and a Δprice of “500 yen”. The prediction information storage unit 123 is not limited to the above description, and may store therein various pieces of information on indices used in the score calculation depending on purposes.

### Control Unit 130

The following description is made with reference to FIG. 2. The control unit 130 is implemented by, for example, a central processing unit (CPU) or a micro processing unit (MPU) executing various computer programs (corresponding to an exemplary prediction program) stored in a storage device in the prediction device 100 by using the RAM as a work area. The control unit 130 is also implemented by, for example, an integrated circuit, such as an application specific integrated circuit (ASIC) and a field programmable gate array (FPGA).

As illustrated in FIG. 2, the control unit 130 includes an acquisition unit 131, a prediction unit 132, and a provision unit 133, and achieves or executes the functionality and effect of information processing described below. The internal configuration of the control unit 130 is not limited to the configuration illustrated in FIG. 2, but may be any other configuration for performing the information processing to be described later. A connection relation between the processing units included in the control unit 130 is not limited to the connection relation illustrated in FIG. 2, but may be any other connection relation.

### Acquisition Unit 131

The acquisition unit 131 acquires information on a current price at which a target product is bid at an auction. For example, the acquisition unit 131 acquires, from the auction information storage unit 122, the information on the current price at which the target product is bid. The acquisition unit 131 may acquire, from an external device that provides an auction service, the information on the current price at which the target product is bid. The acquisition unit 131 may acquire various pieces of information on the auction from an external information processing device. For example, the acquisition unit 131 may acquire information on indices such as the CTR and the CVR other than the Δprice from the external information processing device. For example, the acquisition unit 131 may acquire, as the CTR and the CVR, estimated CTR and CVR estimated by the external information processing device from the external information processing device.

For example, when the prediction device 100 provides an auction service, the acquisition unit 131 acquires information on a product to be put at an auction from an information processing device used by a seller. In this case, the acquisition unit 131 stores the acquired information on the product to be put at an auction in the auction information storage unit 122. For example, when the prediction device 100 provides an auction service, the acquisition unit 131 acquires information on a bid from an information processing device used by a bidder. In this case, the acquisition unit 131 stores the acquired information on a bid in the bid history information storage unit 121.

When the prediction device 100 provides no auction service, the acquisition unit 131 acquires various pieces of information on an auction from an external device that provides an auction service. For example, when the prediction device 100 provides no auction service, the acquisition unit 131 acquires information on a bid history. In this case, the acquisition unit 131 stores the acquired information on a bid in the bid history information storage unit 121. For example, the acquisition unit 131 acquires information on a product put at an auction. In this case, the acquisition unit 131 stores the acquired information on a product put at an auction in the auction information storage unit 122.

### Prediction Unit 132

The prediction unit 132 predicts the Δprice indicating a price difference between the current price and a future price at which the target product is assumed to be bid after bidding at the current price, based on the information on the current price acquired by the acquisition unit 131, and a bid history at an auction. For example, the prediction unit 132 predicts the price difference between the current price and the future price at which the target product is assumed to be bid immediately after bidding at the current price.

The prediction unit 132 uses various pieces of information on en auction to generate the model for predicting the Δprice. For example, the prediction unit 132 uses the information on a bid history stored in the bid history information storage unit 121, and the information on an auction stored in the auction information storage unit 122 so as to generate the model for predicting the Δprice. For example, the prediction unit 132 performs learning by using, as characteristic quantities, items of the “current price”, the “number of bids”, the “number of bidders”, the “remaining hours”, the “category”, and the “title” stared in the auction information storage unit 122, so as to generate the model for predicting the Δprice. The prediction unit 132 is not limited to the above description, and uses, as a characteristic quantity, various pieces of information assumed to be related to the Δprice, so as to generate the model for predicting the Δprice. For example, the prediction unit 132 may use information on a market price of each product as a characteristic quantity so as to generate the model for predicting the Δprice.

For example, when generating a model for predicting the Δprice indicating a price difference between the current price of a product and a future price at which the product is assumed to be bid immediately after bidding at the current price, the prediction unit 132 may perform learning by using information on successive bids on the same product as teaching data so as to generate the model for predicting the Δprice. For example, when generating a model for predicting the Δprice between bidding at the current price and the second bid after the bidding at the current price, the prediction unit 132 may perform learning by using information on every other bid on the same product as teaching data so as to generate the model for predicting the Δprice.

The prediction unit 132 may generate the model for predicting the Δprice for each category. For example, when generating a model related to the category “smartphone”, the prediction unit 132 uses various pieces of information on an auction related to a product belonging to the category “smartphone”, so as to generate the model for predicting the Δprice of a product in the category “smartphone”. In this manner, the prediction unit 132 uses a model generated for each category, thereby improving the accuracy of predicting the Δprice.

The above-described learning is exemplary, and the prediction unit 132 may use various kinds of conventional techniques to generate the model for predicting the Δprice. Alternatively, the prediction unit 132 may use a model for predicting the Δprice generated by an external information processing device through, for example, the above-described learning. In this case, the prediction unit 132 uses a model for predicting the Δprice acquired by, for example, the acquisition unit 131 from the external information processing device, and the prediction unit 132 does not need to perform the above-described learning.

Using a model generated as described above, the prediction unit 132 predicts the Δprice indicating the price difference between the current price of a target product and a future price at which the target product is assumed to be bid after bidding at the current price.

The prediction unit 132 calculates a score as a reference for determining the priorities (ranks) of target products, based on information on an operation by a user on each target product. The prediction unit 132 calculates the score as the reference for determining the priorities (ranks) of the target products based on the number of times that an operation to transition to a page for an auction related to each target product has been performed or the number of times that the target product has been bid. For example, the prediction unit 132 calculates the score as the reference for determining the priorities (ranks) of the target products based on the Δprice related to each target product, the number of times that an operation to transition to a page for an auction related to the target product has been performed, and the number of times that the target product has been bid. In the example illustrated in FIG. 1, the prediction unit 132 calculates the score based on the Δprice, the CTR, and the CVR. For example, the prediction unit 132 calculates the score by Expression (1) below.

y=f1(CTR)×f2(CVR)×f3(Δprice) (1)

The value y on the left side of Expression (1) represents the score. The function f1(CTR) on the right side of Expression (1) represents a function f1 of the CTR as an input variable. The function f2(CVR) on the right side of Expression (1) represents a function f2 of the CVR as an input variable. The function f3(Δprice) en the right side of Expression (1) represents a function f3 of the Δprice as an input variable. The functions f1 to f3 may be selectively various kinds of functions depending on purposes as appropriate, and may be linear or non-linear functions. In this manner, the prediction unit 132 adjusts weights of indices such as the Δprice, the CTR, and the CVR through the functions f1 to f3 so as to calculate the score.

For example, in order to raise the rate of visit to a product page, the prediction unit 132 selects the functions f1 to f3 so that the CTR has an increased weight. For example, in order to increase the number of bids and the number of buys, the prediction unit 132 selects the functions f1 to f3 so that the CVR has an increased weight. For example, in order to raise a unit price per buy, the prediction unit 132 selects the functions f1 to f3 so that the Δprice has an increased weight.

In the example illustrated in FIG. 1, the prediction unit 132 calculates, through Expression (1), the score of the product G11 to be 3.5, the score of the product G12 to be 1.2, the score of the product G13 to be 4.8, and the score of the product G14 to be 5.5.

The prediction unit 132 determines the orders (ranks) of the products based on the calculated scores. For example, the prediction unit 132 determines that a product having a higher score is a product having a higher priority. In the example illustrated in FIG. 1, the prediction unit 132 determines the product G14 having the highest score to be the first rank, the product G13 having the next highest score following the product G14 to be the second rank, the product G11 having the next highest score following the product G13 to be the third rank, and the product G12 having the lowest score to be the fourth rank.

In order to maximize a profit obtained by a provider that provides an auction service, the prediction unit 132 may calculate a score through Expression (2) below.

y=CTR×CVR×Δprice (2)

The value y on the left side of Expression (2) represents the score. In this manner, the prediction unit 132 sets the weight of each index to one (identical) and calculates the score as the product of the indices.

### Provision Unit 133

The provision unit 133 provides information on an auction based on the Δprice as the price difference predicted by the prediction unit 132. For example, the provision unit 133 prioritizes a target product having a higher priority based on the Δprice as the price difference among a plurality of target products, and provides information on the target product as the information on an auction. Specifically, the provision unit 133 provides list information in which information on a target product having a higher priority is displayed at a higher place. In the example illustrated in FIG. 1, the provision unit 133 provides the terminal device 10 with, as auction information, list information displayed in the order of the products G14, 313, G11, and G12.

### 3. Configuration of Terminal Device

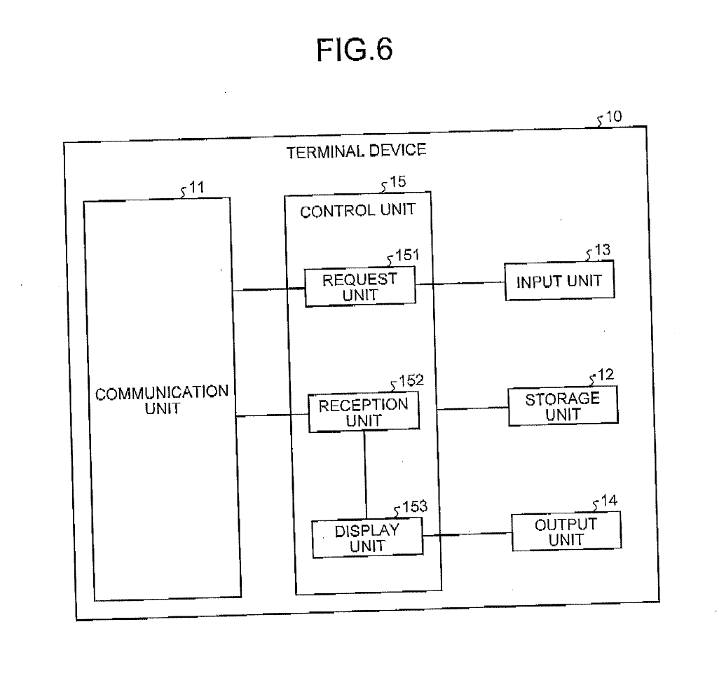

Next, the configuration of the terminal device 10 according to the embodiment will be described with reference to FIG. 6. FIG. 6 is a diagram illustrating an exemplary configuration of the terminal device 10 according to the embodiment. As illustrated in FIG. 6, the terminal device 10 includes a communication unit 11, a storage unit 12, an input unit 13, an output unit 14, and a control unit 15.

### Communication Unit 11

The communication unit 11 is, for example, a communication circuit. The communication unit 11 is connected with the predetermined network not illustrated in a wired or wireless manner, and communicates information with the prediction device 100.

### Storage Unit 12

The storage unit 12 is, for example, a semiconductor memory element, such as a RAM and a flash memory, or a storage device, such as a hard disk and an optical disk. The storage unit 12 stores therein information on an application installed on the terminal device 10, for example, a computer program.

### Input Unit 13

The input unit 13 receives various operations from a user. For example, the input unit 13 may receive various operations from the user through a display surface by exploiting a touch panel function. The input unit 13 may also receive various operations from a button provided to the terminal device 10, and a keyboard and a mouse connected with the terminal device 10.

### Output Unit 14

The output unit 14 is, for example, a display screen of a tablet terminal implemented by a liquid crystal display, an organic electro-luminescence (EL) display, or the like. The output unit 14 is a display device for displaying various pieces of information.

### Control Unit 15

The control unit 15 is implemented by, for example, a CPU or a MPU executing various computer programs stored in a storage device such as the storage unit 12 in the terminal device 10 by using the RAM as a work area. For example, these various computer programs include an installed application program. The control unit 15 is also implemented by, for example, an integrated circuit, such as an ASIC and an FPGA.

As illustrated in FIG. 6, the control unit 15 includes a request unit 151, a reception unit 152, and a display unit 153, and achieves or executes the functionality and effect of the prediction processing described below. The internal configuration of the control unit 15 is not limited to the configuration illustrated in FIG. 6, but may be any other configuration for performing the prediction processing to be described later. A connection relation between the processing units included in the control unit 15 is not limited to the connection relation illustrated in FIG. 6, but may be any other connection relation.

The request unit 151 transmits an acquisition request to the prediction device 100 in accordance with a user operation received by the input unit 13. In the example illustrated in FIG. 1, the request unit 151 selects the category “smartphone” at an auction site displayed in a predetermined application or a predetermined browser so as to transmit a request to acquire auction information categorized into the category “smartphone” to the prediction device 100.

The reception unit 152 receives the auction information provided from the prediction device 100. Having received the auction information, the reception unit 152 may store the received auction information in the storage unit 12.

The display unit 153 displays the auction information provided from the prediction device 100. For example, the display unit 153 displays, at a higher place, information on a product having a higher rank. In the example illustrated in FIG. 1, the display unit 153 displays auction information GI14 on the product 314 at the first rank in the region AR11 that displays information on a product having the highest rank, an the page W11 that displays auction information in the category “smartphone”. The display unit 153 also displays auction information 3113 on the product G13 at the second rank in the region AR12 that displays information on a product having the second highest rank, on the page W11. In the example illustrated in FIG. 1, when a user touches displayed “NEXT” or “2”, the display unit 153 displays auction information on the product G11 at the third rank and auction information on the product 312 at the fourth rank.

The processing such as selection processing by the control unit 15 as described above may be implemented with, for example, JavaScript (registered trademark). When the processing related to display of auction information as described above is performed by a dedicated application, the control unit 15 may include, for example, an application control unit configured to control a predetermined application or a dedicated application.

### 4. Process of Prediction Processing

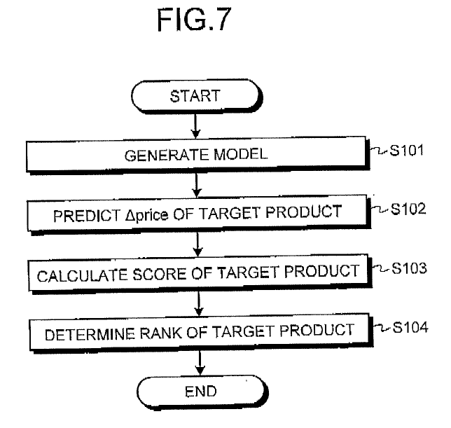

The following describes a procedure of the prediction processing including the rank determination by the prediction system 1 according to the embodiment with reference to FIG. 7. FIG. 7 is a flowchart of an example of the prediction processing according to the embodiment.

As illustrated in FIG. 7, the prediction unit 132 of the prediction device 100 uses various pieces of information on an auction so as to generate a model for predicting the Δprice (step S101). When using a model for predicting the Δprice acquired by the acquisition unit 131 from an external information processing device, the prediction unit 132 does not need to perform the model generation at step S101.

Thereafter, the prediction unit 132 predicts the Δprice of a target product by using the model (step S102). For example, using the model generated at step S101, the prediction unit 132 predicts the Δprice indicating a price difference between the current price of the target product and a future price at which the target product is assumed to be bid immediately after bidding at the current price.

Then, the prediction unit 132 calculates a score of the target product (step S103). For example, the prediction unit 132 calculates the score based on the Δprice related to each target product, the number of times that an operation to transition to a page for an auction related to the target product has been performed, and the number of times that the target product has been bid.

Thereafter, the prediction unit 132 determines the rank of the target product (step S104). For example, the prediction unit 132 determines the rank of the target product based on the calculated score. Specifically, the prediction unit 132 determines that a target product having a higher score is a product having a higher priority.

### 5. Modifications

The prediction system 1 according to the embodiment described above may be achieved in various kinds of different configurations other than the embodiment. The following describes other embodiments of the prediction system 1.

5-1., First Modification: Information Provision to Other Services

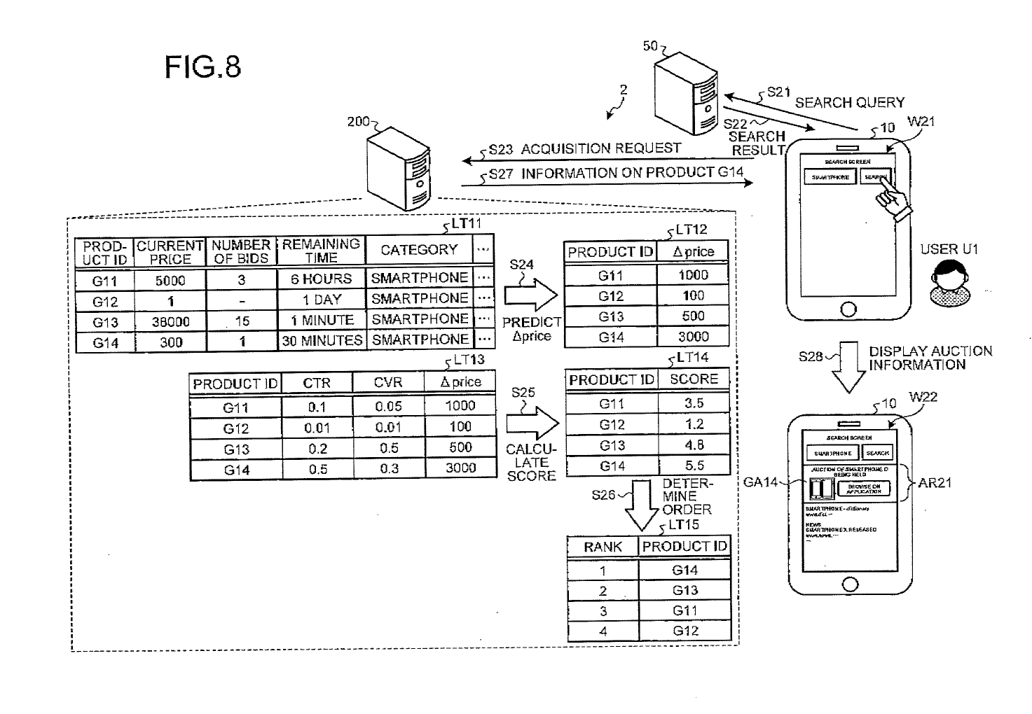

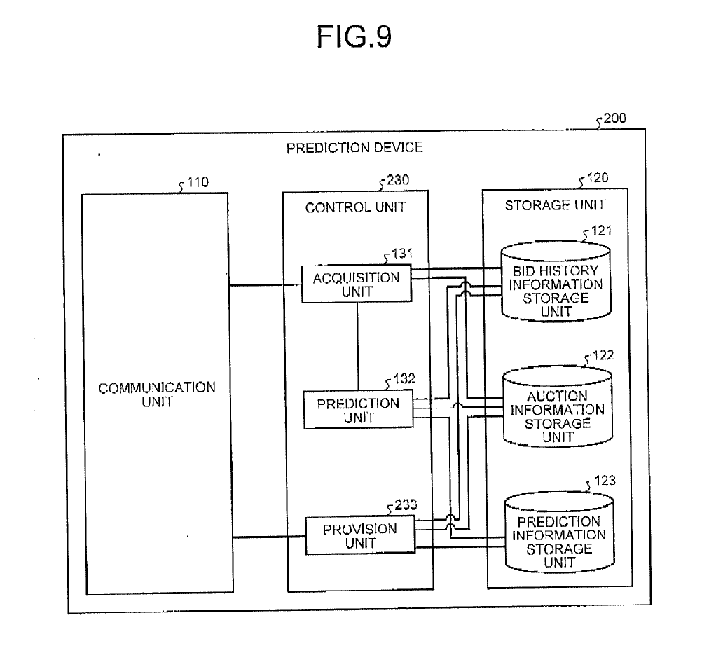

In the example described above, auction information is provided to a user who uses an auction service based on the Δprice. The auction information, however, may be provided to a service other than an auction based on the Δprice. This configuration will be described below with reference to FIGS. 8 and 9. FIG. 8 is a diagram illustrating an example of prediction processing according to a first modification. FIG. 9 is a diagram illustrating an exemplary configuration of a prediction device according to the first modification. Any part identical to that in the embodiment is denoted by an identical reference sign and its description will be omitted. A prediction system 2 illustrated in FIGS. 8 and 9 prioritizes a target product having a higher priority and provides information on the target product to a search service as a service other than an auction.

### 5-1-1. Prediction Processing

The following first describes an example of the prediction processing according to the embodiment with reference to FIG. 8. FIG. 8 is a diagram illustrating an example of the prediction processing according to the first modification. A prediction device 200 illustrated in FIG. 8 predicts a price difference between the current price of a target product and a future price at which the target product is assumed to be bid immediately after bidding at the current price, Then, the prediction device 200 provides the terminal device 10 with information on an auction based on the predicted price difference. Hereinafter, the price difference predicted by the prediction device 200 is also referred to as a “Δprice”.

As illustrated in FIG. 8, the prediction system 2 includes the terminal device 10, a search device 50, and the prediction device 200. The terminal device 10, the search device 50, and the prediction device 200 are connected with each other through the predetermined network not illustrated so as to enable wired or wireless communication. The prediction system 2 illustrated in FIG. 8 may include a plurality of the terminal devices 10 and a plurality of the prediction devices 200.

The search device 50 is an information processing device that provides a search service of displaying a search result for a search query input by a user through the terminal device 10.

The terminal device 10 first transmits the search query input by the user to the search device 50 (step S21). In the example illustrated in FIG. 8, the user inputs a search query “smartphone” into a search window on a page W21 displaying a search screen displayed on a screen of the terminal device 10, and then the user presses a search button. Then, the terminal device 10 transmits the search query “smartphone” to the search device 50.

Having received the search query from the terminal device 10, the search device 50 transmits a received search result to the terminal device 10 (step S22). Having received the search result from the search device 50, the terminal device 10 transmits a request to acquire auction information to the prediction device 200 (step S23). In the example illustrated in FIG. 8, the terminal device 10 transmits a request to acquire auction information categorized into the category “smartphone” to the prediction device 200. Steps S24 to S26 performed by the prediction device 200 are the same as steps S12 to S14 performed by the prediction device 100 illustrated in FIG. 1, and thus description thereof will be omitted.

After having determined the ranks of the products G11 to G14 at step S26, the prediction device 200 provides the auction information to the terminal device 10, which has transmitted the acquisition request at step S23 (step S27). For example, the prediction device 200 provides, as the auction information, information on a product having a highest rank. In the example illustrated in FIG. 8, the prediction device 200 provides information on the product G14 at the first rank to the terminal device 10 as the auction information.

Having received the information on the product G14 from the prediction device 200, the terminal device 10 displays the search result along with the information on the product G14 (step S28). In the example illustrated in FIG. 8, the terminal device 10 displays information GA14 on the product G14 at the first rank in a region AR21 that displays an advertisement such as the auction information, on the page W22 that displays the search result for the search query “smartphone”. In this manner, in the example illustrated in FIG. 8, the terminal device 10 displays information GA14 on the product G14 at the first rank on a screen of the search result displayed by the search service as a service other than an auction.

The prediction device 200 may receive, from the search device 50, a request to acquire auction information. In this case, the prediction device 200 may transmit the information on the product G14 to the search device 50, and the search device 50 may provide the terminal device 10 with the information on the product G14 along with the search result. For example, if a comparison between the score of the product G14 calculated through Expression (2) and an expected profit value related to other advertisements finds that the score of the product G14 is equal to or higher than the expected profit value of other advertisements, the terminal device 10 may display the information on the product G14 in the region AR21. If the score of the product G14 is lower than the expected profit value of other advertisements, the terminal device 10 may display the other advertisements in the region AR21.

For example, the expected profit value related to other advertisements may be an effective cost per mile (eCPM). In this case, the eCPM related to other advertisements may be compared with a value obtained by adjusting the score of the product G14 for a comparison with the eCPM to determine which of the information on the product G14 and the other advertisements to be displayed in the region AR21. In this manner, the prediction system 2 can compare auction information and other advertisements, thereby appropriately determining which of these to be displayed in the region AR21.

### 5-1-2. Configuration of Prediction Device

The following describes the configuration of the prediction device 200 according to the first modification with reference to FIG. 9. FIG. 9 is a diagram illustrating an exemplary configuration of the prediction device according to the first modification. As illustrated in FIG. 9, the prediction device 200 includes the communication unit 110, the storage unit 120, and a control unit 230. The prediction device 200 may include an input unit (for example, a keyboard or a mouse) configured to receive various operations from, for example, an administrator of the prediction device 200, and a display unit (for example, a liquid crystal display) displaying various pieces of information.

### Control Unit 230

The control unit 230 is implemented by, for example, a CPU or a MPU using a RAM as a work area to execute various computer programs (corresponding to an exemplary prediction program) stored in a storage device in the prediction device 200. The control unit 230 is also implemented by, for example, an integrated circuit, such as an ASIC and an FPGA.

As illustrated in FIG. 9, the control unit 230 includes the acquisition unit 131, the prediction unit 132, and a provision unit 233, and achieves or executes the functionality and effect of information processing described below. The internal configuration of the control unit 230 is not limited to the configuration illustrated in FIG. 9, but may be any other configuration for performing the information processing to be described later. A connection relation between the processing units included in the control unit 230 is not limited to the connection relation illustrated in FIG. 9, but may be any other connection relation.

### Provision Unit 233

The provision unit 233 provides information on an auction based on the Δprice as a price difference predicted by the prediction unit 132. For example, the provision unit 233 prioritizes a target product having a higher priority and provides information on the target product to a service other than an auction. In the example illustrated in FIG. 8, the provision unit 233 provides information on the target product to a search service other than an auction. Specifically, in the example illustrated in FIG. 8, the provision unit 233 provides the information on the product G14 having the highest rank to the terminal device 10 using the search service.

### 5-2. Second Modification: Score Calculation

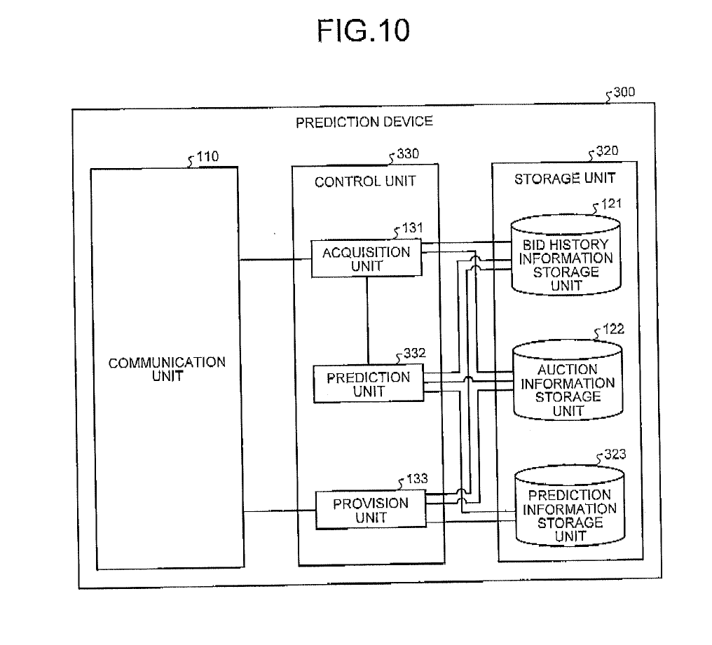

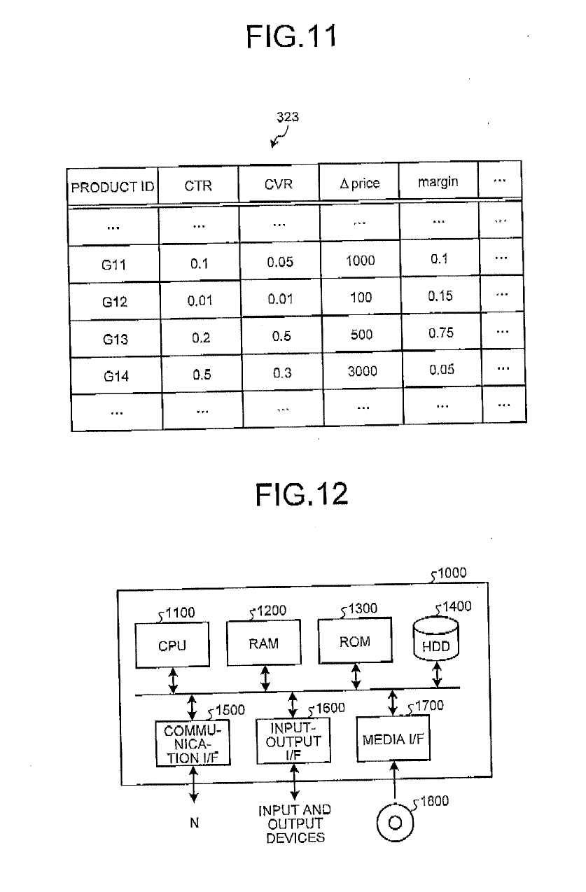

In the embodiment described above, the prediction device 100 calculates a score based on the Δprice, the CTR, and the CVR, but may calculate the score by additionally using any other index. This configuration will be described with reference to FIGS. 10 and 11. FIG. 10 is a diagram illustrating an exemplary configuration of a prediction device according to a second modification. FIG. 11 is a diagram illustrating an exemplary prediction information storage unit according to the second modification. Any part identical to that in the embodiment is denoted by an identical reference sign and its description will be omitted.

### 5-2-1. Configuration of Prediction Device

The following describes the configuration of a prediction device 300 according to the second modification with reference to FIG. 10. FIG. 10 is a diagram illustrating an exemplary configuration of the prediction device according to the second modification. As illustrated in FIG. 10, the prediction device 300 includes the communication unit 110, a storage unit 320, and a control unit 330. The prediction device 300 may include an input unit (for example, a keyboard or a mouse) configured to receive various operations from, for example, an administrator of the prediction device 300, and a display unit (for example, a liquid crystal display) for displaying various pieces of information.

### Storage Unit 320

The storage unit 320 is, for example, a semiconductor memory element, such as a RAM and a flash memory, or a storage device, such as a hard disk and an optical disk. As illustrated in FIG. 10, the storage unit 320 according to the second modification includes the bid history information storage unit 121, the auction information storage unit 122, and a prediction information storage unit 323.

### Prediction Information Storage Unit 323

The prediction information storage 323 unit according to the second modification stores therein various pieces of information on indices used in the score calculation. FIG. 11 is a diagram illustrating an exemplary prediction information storage unit according to the second modification. The prediction information storage unit 323 illustrated in FIG. 11 stores therein items of “product ID”, “CTR”, “CVR”, “Δprice”, and “margin”.

The “margin” indicates a ratio of a fee received by an auction provider to a price when a corresponding product is bought and a deal is made. The “margin” may vary depending on a current price and a category to which the product belongs.

The example illustrated in FIG. 11 indicates that a product identified by product ID “G14” has a CTR of “0.5”, a CVR of “0.3”, a Δprice of “3000 yen”, and a margin of “0.05”. Thus, in the example illustrated in FIG. 10, the prediction information storage unit 323 indicates that the ratio of the tee received by the auction provider is 5% when the product identified by product ID “G14” is bought. The prediction information storage unit 323 is not limited to the above description, but may store therein various pieces of information on indices used in the score calculation depending on purposes.

### Control Unit 330

The control unit 330 is implemented by, for example, a CPU or a MPU using a RAM as a work area to execute various computer programs (corresponding to an exemplary prediction program) stored in a storage device in the prediction device 300. The control unit 330 is also implemented by, for example, an integrated circuit, such as an ASIC and an FPGA.

As illustrated in FIG. 10, the control unit 330 includes the acquisition unit 131, a prediction unit 332, and the provision unit 133, and achieves or executes the functionality and effect of information processing described below. The internal configuration of the control unit 330 is not limited to the configuration illustrated in FIG. 10, but may be any other configuration for performing the information processing to be described later. A connection relation between the processing units included in the control unit 330 is not limited to the connection relation illustrated in FIG. 10, but may be any other connection relation.

### Prediction Unit 332

The prediction unit 332 calculates a score as a reference for determining the priorities (ranks) of the target products, based on information on a fee received by a provider that provides an auction. In this case, the prediction unit 332 calculates the score based on the CTR, the CVR, the Δprice, and the margin. For example, the prediction unit 332 calculates the score through Expression (3) below.

y=f1(CTR)×f2(CVR)×f3(Δprice)×f4(margin) (3)

The value y on the left side of Expression (3) represents the score. The function f1(CTR) on the right side of Expression (3) represents a function f1 of the CTR as an input variable. The function f2(CVR) on the right side of Expression (3) represents a function f2 of the CVR as an input variable. The function f3(Δprice) on the right side of Expression (3) represents a function f3 of the Δprice as an input variable. The function f4(margin) on the right side of Expression (3) represents a function f4 of the margin as an input variable. The functions f1 to f4 may be selectively various kinds of functions depending on purposes as appropriate, and may be linear or non-linear functions. In this manner, the prediction unit 332 adjusts weights of indices such as the margin, the Δprice, the CTR, and the CVR through the functions f1 to f4 so as to calculate the score.

For example, in order to increase a profit rate of a provider that provides an auction, the prediction unit 332 selects the functions f1 to f4 so that the margin has an increased weight. In the example illustrated in FIG. 1, the prediction unit 332 may calculate the scores of the products G11 to G14 through, for example, Expression (3).

### 6. Effects

As described above, the prediction devices 100 to 300 according to the embodiment and the first and the second modifications include the acquisition unit 131, and the prediction unit 132 or 332. The acquisition unit 131 acquires information on a current price at which a target product is bid at an auction. The prediction unit 132 or 332 predicts a price difference (the “Δprice” in the embodiment; the same shall apply hereinafter) between the current price and a future price at which the target product is assumed to be bid after bidding at the current price, based on information on the current price acquired by the acquisition unit 131, and a bid history at an auction.

In this manner, the prediction devices 100 to 300 according to the embodiment and the first and the second modifications predict the Δprice of each product based on information on the current price and a model. The Δprice is information that enables appropriate prediction of which product provides a large profit in the future. In other words, the prediction devices 100 to 300 can accurately predict an immediate profit from the Δprice. The prediction devices 100 to 300 can perform auction management including the Δprice as a factor indicating which product provides a profit. Thus, the prediction devices 100 to 300 can facilitate auction management by using the Δprice enabling appropriate prediction of a future profit.

The prediction devices 100 to 300 according to the embodiment and the first and the second modifications include the provision unit 133 or 233. The provision unit 133 or 233 provides information on an auction based on the price difference predicted by the prediction unit 132 or 332.

In this manner, the prediction devices 100 to 300 according to the embodiment and the first and the second modifications can provide information on an auction appropriately based on the Δprice. In other words, the prediction devices 100 to 300 can appropriately provide information in accordance with a price difference between the current price and a future price at an auction.

In the prediction devices 100 to 300 according to the embodiment and the first and the second modifications, the provision unit 133 or 233 prioritizes a target product having a higher priority based on the price difference among a plurality of target products and provides information on the target product as information on an auction.

In this manner, the prediction devices 100 to 300 according to the embodiment and the first and the second modifications can provide information on an appropriately ranked product based on the difference between the current price and the future price.

In the prediction devices 100 to 300 according to the embodiment and the first and the second modifications, the provision unit 133 or 233 prioritizes a target product having a higher priority based on information on an operation by a user on each target product, and provides information on the target product.

In this manner, the prediction devices 100 to 300 according to the embodiment and the first and the second modifications can provide information on an appropriately ranked product based on the information on an operation by the user on the target product.

In the prediction devices 100 to 300 according to the embodiment and the first and the second modifications, the provision unit 133 or 233 prioritizes a target product having a higher priority based on the number of times (corresponding to the “CTR” in the embodiment; the same shall apply hereinafter) that an operation to transition to a page for an auction related to each target product has been performed or the number of times (corresponding to the “CVR” in the embodiment; the same shall apply hereinafter) that the target product has been bid, and provides information on the target product.

In this manner, the prediction devices 100 to 300 according to the embodiment and the first and the second modifications can provide information on an appropriately ranked product based on other indices such as the CTR and the CVR in addition to the Δprice. Accordingly, the prediction devices 100 to 300 can provide information on an appropriately ranked product depending on purposes.

In the prediction device 300 according to the second modification, the provision unit 133 prioritizes a target product having a higher priority based on information (corresponding to the “margin” in the second modification; the same shall apply hereinafter) on a fee received by a provider that provides an auction, and provides information on the target product.

In this manner, the prediction device 300 according to the second modification can provide information on an appropriately ranked product based on the margin as information on a fee received by a provider that provides an auction, in addition to the Δprice, the CTR, and the CVR. Accordingly, the prediction devices 100 to 300 can provide information on an appropriately ranked product based on a profit of a provider that provides an auction.

In the prediction device 200 according to the first modification, the provision unit 233 prioritizes a target product having a higher priority and provides information on the target product to a service other than an auction.

In this manner, the prediction device 200 according to the first modification can provide information on an appropriately ranked product to various kinds of services other than an auction.

In the prediction device 100 and 300 according to the embodiment and the second modification, the provision unit 133 provides list information in which information on a target product having a higher priority is displayed at a higher place.

In this manner, the prediction device 100 and 300 according to the embodiment and the second modification can provide list information of which display order is appropriately determined based on the Δprice. The terminal device 10 can appropriately display information on a product based on its rank determined by the prediction device 100 and 300.

In the prediction devices 100 to 300 according to the embodiment and the first and the second modifications, the prediction unit 132 or 332 predicts a price difference between the current price of a target product and a future price at which the target product is assumed to be bid immediately after bidding at the current price.

In this manner, the prediction devices 100 to 300 according to the embodiment and the first and the second modifications can predict a price difference between the current price and a price at which the target product is bid next, thereby accurately predicting an immediate profit based on the Δprice.

In the prediction devices 100 to 300 according to the embodiment and the first and the second modifications, the prediction unit 132 or 332 predicts a price difference related to a target product based on a bid history related to a product in a category to which the target product belongs.

In this manner, the prediction devices 100 to 300 according to the embodiment and the first and the second modifications predicts the Δprice for each category, thereby improving the accuracy of the prediction. For example, when generating a model related to the category “smartphone”, the prediction devices 100 to 300 use various pieces of information on an auction related to a product belonging to the category “smartphone” so as to generate the model for predicting the Δprice of the product in the category “smartphone”. In this manner, the prediction devices 100 to 300 can improve the accuracy of the prediction of the Δprice by using a model generated for each category.

### 7. Hardware Configuration

The prediction devices 100 to 300 according to the embodiment and the first and the second modifications described above are implemented by a computer 1000 having, for example, a configuration illustrated in FIG. 12. FIG. 12 is a hardware configuration diagram illustrating an example of the computer 1000 that achieves the functionalities of the prediction devices 100 to 300. The computer 1000 includes a CPU 1100, a RAM 1200, a ROM 1300, a HDD 1400, a communication interface (I/F) 1500, an input-output interface (1/F) 1600, and a media interface (I/F) 1700.

The CPU 1100 operates in accordance with a computer program stored in the ROM 1300 or the HDD 1400, and controls each component of the computer 1000. The ROM 1300 stores therein, for example, a boot program executed by the CPU 1100 when the computer 1000 starts up, and a computer program dependent on the hardware of the computer 1000.

The HDD 1400 stores therein, for example, a computer program executed by the CPU 1100 and data used by the computer program. The communication interface 1500 receives data from another instrument through a network N and transmits the data to the CPU 1100, and then transmits data generated by the CPU 1100 to the instrument through the network N.

The CPU 1100 controls output devices, such as a display and a printer, and input devices, such as a keyboard and a mouse, through the input-output interface 1600. The CPU 1100 acquires data from the input devices through the input-output interface 1600. The CPU 1100 outputs generated data to the output devices through the input-output interface 1600.

The media interface 1700 reads a computer program or data stored in a recording medium 1800, and provides the computer program or data to the CPU 1100 through the RAM 1200. The CPU 1100 loads the computer program onto the RAM 1200 from the recording medium 1800 through the media interface 1700, and executes the loaded program. Examples of the recording medium 1800 include optical recording media, such as a digital versatile disc (DVD) and a phase change rewritable disk (PD), a magneto optical recording medium, such as a magneto-optical disk (MO), a tape medium, a magnetic recording medium, and a semiconductor memory.

For example, when the computer 1000 serves as the prediction devices 100 to 300 according to the embodiment and the first and the second modifications, the CPU 1100 of the computer 1000 achieves functions of the control units 130, 230, and 330 by executing computer programs loaded on the RAM 1200. The CPU 1100 of the computer 1000 reads these computer programs from the recording medium 1800 and executes the computer programs, but in another example, may acquire these programs from another device through the network N.

The embodiment and the first and the second modifications of the present application are described above in detail with reference to the drawings, but these are merely examples. The present invention may be performed in other configurations in which various kinds of changes and modifications are applied based on the knowledge of the skilled person in the art, in addition to aspects described in the section of the disclosure of the invention.

### 8. Other Embodiments

Among the pieces of processing described in the embodiment and the first and the second modifications, all or some pieces of processing described as automatically performed processing may be manually performed, or all or some pieces of processing described as manually performed processing may be automatically performed by the well-known method. In addition, information including processing procedures, specific names, various kinds of data and parameters described in the above specification and drawings may be optionally changed unless otherwise stated. For example, various pieces of information described with reference to the drawings are not limited to the information illustrated in the drawings.

Components of devices illustrated in the drawings represent conceptual functions and are not necessarily need to be physically configured as illustrated in the drawings. In other words, specific configurations of distribution and integration of the devices are not limited to the illustrated configurations. All or some of the devices may be functionally or physically distributed and integrated in optional units depending on various loads and use conditions.

The embodiment and the first and the second modifications described above may be combined as appropriate while consistency of processing contents is maintained.

Any “unit” in the above description is interchangeable with “means” and “circuit”. For example, “acquisition unit” is interchangeable with “acquisition means” and “acquisition circuit”.

According to an embodiment, auction management can be facilitated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A prediction device comprising:
an acquisition unit that acquire information on a current price at which a target product is bid at an auction; and
a prediction unit that predict a price difference between the current price and a future price at which the target product is assumed to be bid after bidding at the current price based on the information on the current price acquired by the acquisition unit and a bid history at the auction.

2. The prediction device according to claim 1, further comprising a provision unit that provide information on the auction based on the price difference predicted by the prediction unit.

3. The prediction device according to claim 2, wherein the provision unit prioritizes a target product having a higher priority based on the price difference among a plurality of target products, and provides information on the target product as the information on the auction.

4. The prediction device according to claim 3, wherein the provision unit prioritizes a target product having a higher priority based on information on an operation on each target product by a user, and provides information on the target product.

5. The prediction device according to claim 4, wherein the provision unit prioritizes a target product having a higher priority based on the number of times that an operation to transition to a page for an auction related to the target product has been performed or the number of times that the target product has been bid, and provides information on the target product.

6. The prediction device according to claim 3, wherein the provision unit prioritizes a target product having a higher priority based on information on a fee received by a provider that provides the auction, and provides information on the target product.

7. The prediction device according to claim 3, wherein the provision unit prioritizes a target product the priority of which is higher and provides information on the target product to a service other than the auction.

8. The prediction device according to claim 3, wherein the provision unit provides list information in which information on a target product the priority of which is higher is displayed at a higher place.

9. The prediction device according to claim 1, wherein the prediction unit predicts a price difference between the current price and the future price at which the target product is assumed to be bid immediately after bidding at the current price.

10. The prediction device according to claim 1, wherein the prediction unit predicts the price difference related to the target product based on a bid history related to a product in a category to which the target product belongs.

11. A prediction method executed by a computer, the prediction method comprising:
acquiring information on a current price at which a target product is bid at an auction; and
predicting a price difference between the current price and a future price at which the target product is assumed to be bid after bidding at the current price based on the information on the current price acquired at the acquiring and a bid history at the auction.

12. A non-transitory computer-readable storage medium having stored therein a prediction program that causes a computer to execute a process comprising:
acquiring information on a current price at which a target product is bid at an auction; and
predicting a price difference between the current price and a future price at which the target product is assumed to be bid after bidding at the current price based on the information on the current price acquired at the acquiring and a bid history at the auction.
